(19) United States
(12) Patent Application Publication
(10) Pub. No.: US 2011/0307538 A1
(43) Pub. Date: Dec. 15, 2011

(54) NETWORK BASED PEER-TO-PEER TRAFFIC OPTIMIZATION

(75) Inventors: Ivica Rimac, Tinton Falls, NJ (US); Volker Friedrich Hilt, Middletown, NJ (US)

(73) Assignee: Alcatel-Lucent USA, Inc., Murray Hill, NJ (US)

(21) Appl. No.: 12/813,026

(22) Filed: Jun. 10, 2010

(51) Int. Cl. G06F 15/16

(52) U.S. Cl. 709/202; 709/206; 709/204

(57) ABSTRACT

A peer-to-peer accelerator system is disclosed for reducing reverse link bandwidth bottlenecking of peer-to-peer content transfers. The peer-to-peer accelerator system contains a peer-to-peer proxy which resides in the core of the network. When a peer-to-peer bootstrap message from an asymmetrically connected client occurs, the proxy intercepts the message and instantiates an agent which will perform file transfers on the asymmetrically connected client's behalf thereby eliminating the need for the client to effect file content transfers over the reverse link. The peer-to-peer accelerator system is particularly useful for overcoming the bottlenecking and reverse link contention problems of peer-to-peer file transfer systems known in the art.

### FIELD OF THE INVENTION

The invention relates to peer-to-peer data sharing and is particularly concerned with eliminating uplink usage of peer-to-peer network clients connected via asymmetric links to a network to effectively decrease access network contention level as well as improve the user experience.

### BACKGROUND OF THE INVENTION

Peer-to-peer (P2P) content distribution solutions (for example, peer-to-peer networks based on the BitTorrent protocol) require content sinks to also actively serve content fragments to other participants of the peer-to-peer network. As an effect of the protocol, in order for a peer to finish its own download of the complete file, it needs to make available the pieces it has already received from the other participants. This results in data transmission over the reverse link i.e. the client device is acting as a server to other participants.

A number of incentive mechanisms are implemented in widely-used peer-to-peer overlays, which assess the amount of data that a client has uploaded versus downloaded. Peers which have poor share ratios may face sanctions throttling the rates at which new pieces may be obtained and so require uplink resources in order to maintain their own Quality-of-Experience (QoE). If the uplink share of a peer-to-peer user is low (which is the case particularly for asymmetric access technologies), the peer's forward link performance will be degraded by the overlay following due to the implemented reciprocation mechanism.

As a consequence, network operators will experience high contention ratios on the reverse link (e.g., the airlink in a mobile network or an oversubscribed aggregation link in a DSL network) due to bandwidth-hungry peer-to-peer client applications seeking to maintain their peer-to-peer networking share ratios. This directly implies higher OPEX for the operators and decreased quality of experience (QoE) for all users. In a cellular network in particular, scarce air resources will be used very inefficiently since the same data will be transmitted first on the downlink and then uplink again.

A series of examples will illustrate the phenomena. In the following discussion the term asymmetrical connection refers to a data connection in which the forward link bandwidth is greater than the reverse link bandwidth.

Referring to FIG. 1, there may be seen a peer-to-peer data sharing network implementation 100, wherein the IP Network 102 connects members of a P2P Overlay Network 104. A client 106 has a connection 110a and 110b to an end host 112 through IP Network 102 to other members 108 of the P2P swarm. In this implementation, no differentiation is made with respect to the separate bandwidths of connections 100a and 100b.

Referring now to FIG. 2, there may be seen a peer-to-peer data sharing network implementation 200 which has client links of asymmetrical bandwidth on the forward and reverse links. In operation, IP Network 202 and Mobile Network 220 operate to connect members of P2P Overlay Network 204. A client 216 has an ADSL connection to the IP Network 202 via DSLAM 214. Additional mobile clients 217, 218, and 219 are connected wirelessly to Mobile Network 220 via a wireless interface 224 which may be an eNodeB/Radio Network Controller by way of example. Mobile network 220 is connected to IP Network 202 via IP Gateway 222. The peer-to-peer overlay network 204 may use the interconnected networks for file sharing, but the forward and reverse link bandwidths are neither the same, nor symmetrical for many of the clients. Clients 208 may be connected to the IP Network 202 with symmetrical high-speed links 210a and 210b. On the other hand client 216 is connected to IP Network 202 via an ADSL connection which has a significantly lower reverse link bandwidth. (See Table 2 infra, for examples.) As well, clients 217, 218, and 219 are also connected with asymmetrical radio links through the Mobile Network 220. (See Table 1, infra, for examples.) In operation, clients 216, 217, 218, and 219 will be expected via P2P tit-for-tat protocol to operate to have share ratios approaching unity. Due to the reduced bandwidth reverse links, the experience of both these clients, and other members of the peer-to-peer network is degraded by the reverse link lower bandwidths.

Some examples of mobile networks with asymmetrical reverse link speeds are given in Table 1.

TABLE 1

| | | | | Downlink | Uplink |
|---|---|---|---|---|---|
| Standard | Family | Primary Use | Radio Tech | (Mbit/s) | (Mbit/s) |
| LTE | UMTS-4GSM | General 4G | OFDMA | 360 | 80 |
| WiMAX | 802.16e | Mobile Internet | MIMO-SOFDMA | 144 | 35 |
| Edge Evolution | GSM | Mobile internet | TDMA/FDD | 1.9 | 0.9 |
| W-CDMA HSDPA | UMTS/3GSM | Mobile Internet | CDMA/FDD | 14.4 | 5.76 |

Some examples of wired network connection with asymmetrical reverse link speeds are given in Table 2.

TABLE 2

| | | Downlink | | Uplink |
|---|---|---|---|---|
| Standard | Common Name | (Mbit/s) | | (Mbit/s) |
| ANSI T1.413-1998 | ADSL | 8 | Mbit/s | 1.0 Mbit/s |
| Issue 2 | | | | |
| ITU G.992.1 | ADSL (G.DMT) | 12 | Mbit/s | 1.3 Mbit/s |
| ITU G.992.2 | ADSL Lite (G.Lite) | 1.5 | Mbit/s | 0.5 Mbit/s |
| ITU G.992.3 | ADSL2 | 12 | Mbit/s | 1.0 Mbit/s |
| ITU G.992.4 | splitterless ADSL2 | 1.5 | Mbit/s | 0.5 Mbit/s |
| ITU G.992.5 | ADSL2+ | 24 | Mbit/s | 1.0 Mbit/s |

Therefore, it would be desirable for system operators to have a method of more efficiently managing the operation of reciprocation mechanisms in peer-to-peer networks having asymmetrical client connections to lessen the impact on reverse links. It would be further desirable for such a method to not incur the expense and complications of revising the client-side peer-to-peer software.

### SUMMARY OF THE INVENTION

It is an object of the invention to provide a system and method for reducing reverse link bandwidth consumption for clients of peer-to-peer networks having an asymmetrical connection to the data network over which the peer-to-peer network operates.

According to an aspect of the invention there is provided a system for reducing reverse link bandwidth consumption in peer-to-peer networks, said system having a data network; a peer-to-peer network operating in conjunction with said data network; a client having an asymmetrical connection to said data network; and a peer-to-peer proxy server located in said data network; and wherein the peer-to-peer proxy server has a dedicated function of interfacing between the client and the peer-to-peer network.

In some embodiments of the invention the peer-to-peer proxy server has a tracker proxy for receiving bootstrap messages from an asymmetrically connected client; and a mechanism for instantiating a peer-to-peer agent to represent a given asymmetrically connected client to the peer-to-peer network.

In some embodiments of the invention the asymmetrical connection is a wireline connection, for example, an ADSL connection. In other embodiments of the invention the asymmetrical connection is a wireless connection, for example, an LTE connection, a WiMAX connection, a UMTS connection or a GSM connection.

In some embodiments of the invention the peer-to-peer network operates using a BitTorrent protocol; and the agent interfaces to the peer-to-peer network emulating a client using BitTorrent protocol.

According to another aspect of the invention there is provided a method for reducing reverse link bandwidth consumption in a peer-to-peer network operating in conjunction with a data network having at least one asymmetrically connected client. The method has the steps of: intercepting a bootstrap message from the asymmetrically connected client; instantiating an agent to represent the client; performing peer-to-peer message exchanges from the agent to other peers wherein the agent performs content transfers normally performed by the asymmetrically connected client; performing peer-to-peer message exchanges from the agent to the client wherein the agent performs content transfers normally performed by other peers to the client; and avoiding requesting file content transfers from the client to the agent over the client's reverse link.

According to yet another aspect of the invention there is provided an article of manufacture having a machine-accessible medium having instructions encoded thereon for enabling a processor to perform the operations of intercepting a bootstrap message from an asymmetrically connected client connected to a data network; instantiating an agent to represent the client to a peer-to-peer network operating in conjunction with the data network; performing peer-to-peer message exchanges from the agent to other peers wherein the agent performs content transfers normally performed by the asymmetrically connected client; performing peer-to-peer message exchanges from the agent to the client wherein the agent performs content transfers normally performed by other peers to the client; and avoiding requesting file content transfers from the client to the agent over the client's reverse link.

Note: in the following the description and drawings merely illustrate the principles of the invention. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

### BRIEF DESCRIPTION OF THE DRAWINGS

The present invention will be further understood from the following detailed description of embodiments of the invention, with reference to the drawings in which:

FIG. 1 illustrates an example of an overlay peer-to-peer network in accordance with the known art;

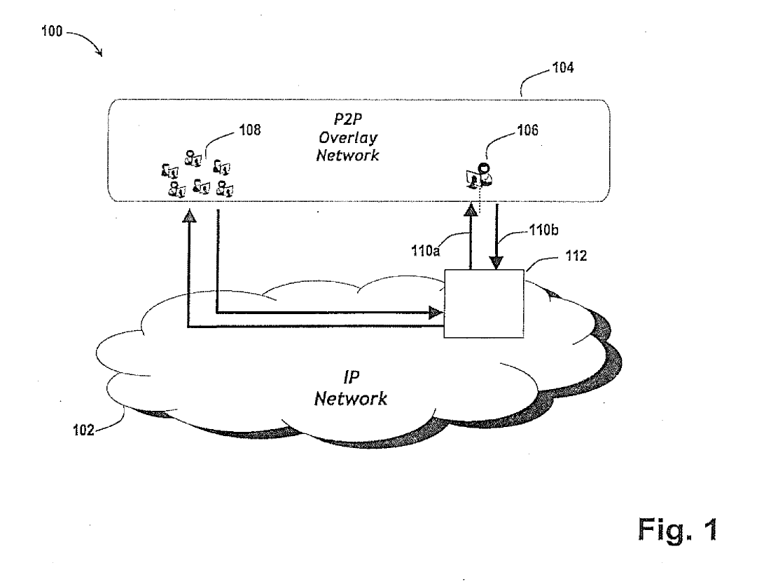

FIG. 2 illustrates an example of an overlay peer-to-peer network with asymmetric client connections in accordance with the known art;

FIG. 3 illustrates an example message flow diagram for a client operating a peer-to-peer protocol in the network of FIG. 2 in accordance with the known art; and

FIG. 4 illustrates an example of an overlay peer-to-peer network in conjunction with an embodiment of the present invention; and

FIG. 5 illustrates an example message flow diagram for a client operating a peer-to-peer protocol in the network of FIG. 4.

### DETAILED DESCRIPTION

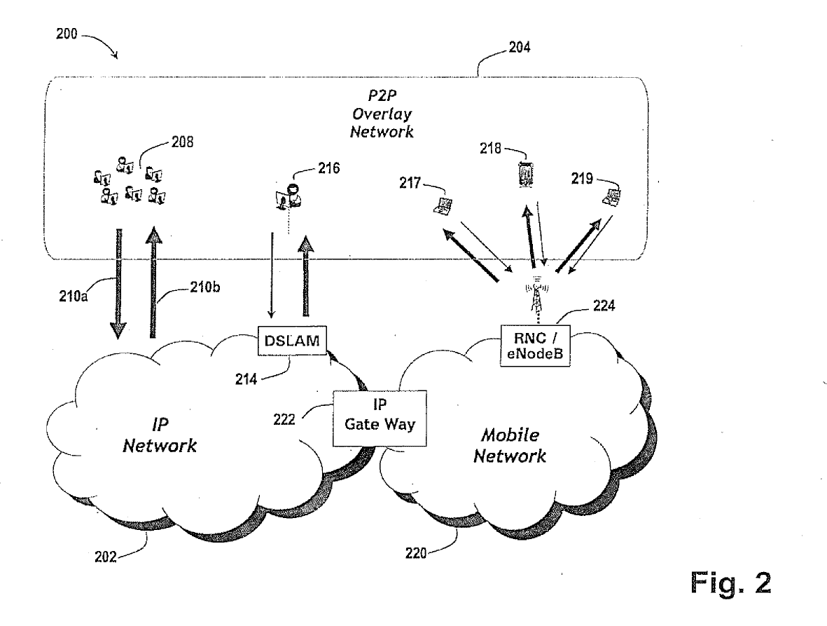

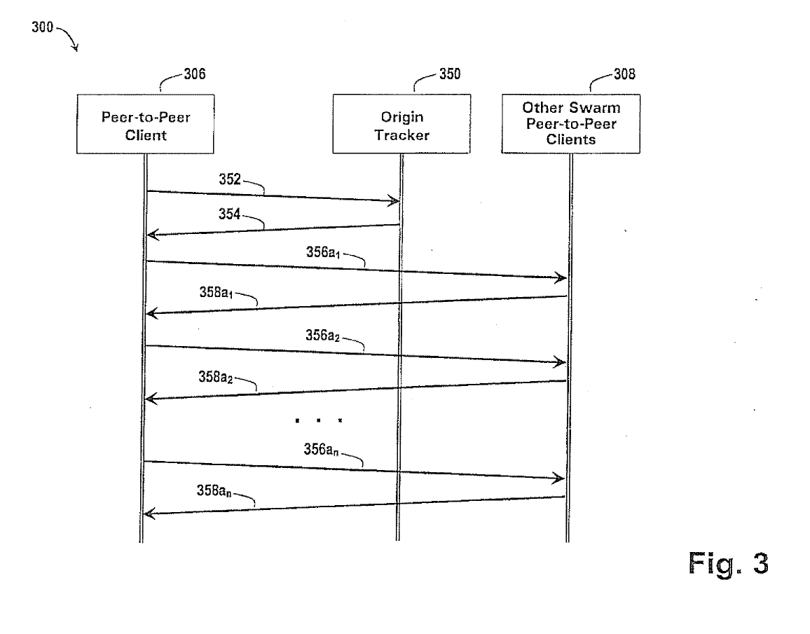

Referring to FIG. 3 there may be seen a message flow diagram 300 representative of a client joining a P2P overlay network 204 of FIG. 2. Represented in the message flow diagram are Peer-to-Peer Client 306, Origin Tracker 350, and other swarm peer-to-peer clients 308. In joining the swarm, client 306 sends bootstrap message 352 to origin tracker 350. Origin tracker 350 adds client 306 to its list of participating peers and responds to message 352 with a peer list message 354 listing peers which may be accessed for the content which client 306 is seeking. Having the addresses of other swarm members, client 306 then engages in the normal peer-to-peer protocol of message exchanges (356a₁ and 358a₁; 356a₂ and 358a₂; . . . ; 356aₙ, and 358aₙ) which convey the relevant portions of the desired content to client 306 and from client 306 to other members of the constituted peer-to-peer swarm. Furthermore, other peers may receive the address of client 306 in response to their message exchange with the origin tracker 350, which would allow those peers to initiate a peer-to-peer exchange with client 306. In that case the message flow is reversed. As previously discussed, client 306 has a share ratio established by the proportions of content received via message exchanges 356 and transmitted to other swarm members via message exchanges 358. If client 306 is connected to the network via an asymmetrical connection, then the bandwidth available for message exchanges 358 will be significantly less than message exchanges 356. Accordingly, client 306 will either have to suffer a reduced share ratio, or client 306 and other swarm members will have to suffer extended transmission times in order to generate share ratios approaching unity.

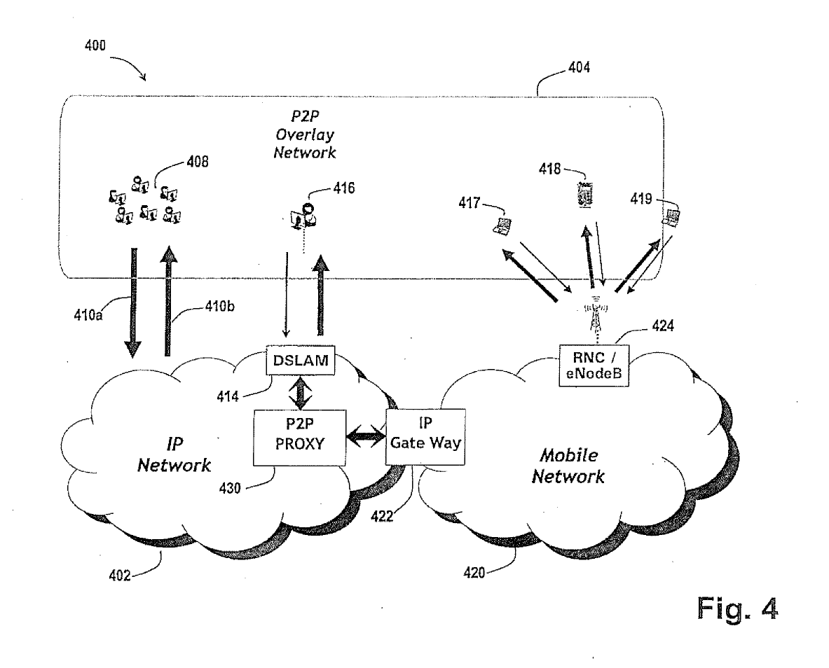

Referring now to FIG. 4, there may be seen a peer-to-peer data sharing network implementation 400 according to an embodiment of the invention which has client links of asymmetrical bandwidth on the forward and reverse links. In operation, IP Network 402 and Mobile Network 420 operate to connect members of P2P Overlay Network 404. A client 416 has an ADSL connection to the IP Network 402 via DSLAM 414. Additional mobile clients 417, 418, and 419 are connected wirelessly to Mobile Network 420 via a wireless interface 424 which, by way of example, may be an eNodeB/Radio Network Controller. Mobile network 420 is connected to IP Network 402 via IP Gateway 422. In addition, Peer-to-Peer Proxy 430 is operatively connected to DSLAM 414 and IP Gate Way 422, and interacts with the peer-to-peer protocol messaging between P2P clients 408, 416, 417, 418, and 419 so as to overcome the effects of the reduced reverse link bandwidth for those clients with asymmetrical network connections.

In operation an asymmetrical peer-to-peer client's bootstrap message, for example from any of clients 416, 417, 418, and 419, is transparently intercepted by a peer-to-peer proxy 430 implemented in the operator's IP core. The proxy 430 instantiates an agent for the asymmetrical client and replies with the agent's ID and address to the bootstrap request. The agent performs the regular peer-to-peer joining and message exchange procedures, i.e., it first contacts the origin bootstrap server (tracker) to request a list of peers to connect to. For the actual exchange with other peers an agent also needs meta-information that describe the content. In BitTorrent, as an example, this is usually conveyed in the .torrent file that a client downloads from a website. Besides the URL of one or more trackers, the meta-file includes important information such as chunk size and chunk hashes.

According to different embodiments, there are different methods for the agent to obtain the meta-information. According to one method, when the agent is instantiated, is uses the meta-exchange option supported by some BitTorrent clients to fetch the meta-information from the client or other peers.

According to an alternative method, when the agent is instantiated, it generates the magnet link for the content and uses the magnet link to retrieve the meta info from the local client or other peers it connects to using a Distributed Hash Table.

According to yet another method, meta files that the peer-to-peer optimizer/manager is configured to serve may be preloaded offline onto a file system or a database. The instantiated agent can access this information at instantiation time.

According to yet another method, when the agent is instantiated by the proxy, it would use the origin file identifier to search for the associated meta file on the Internet.

Once the list is available, the agent connects to the provided peers and exchanges data with them using the peer-to-peer content exchange protocol (e.g., using the BitTorrent protocol) as if it were the originating client. As the proxy 430 is located within the network, no reverse link bandwidth reduction effects are present. Concurrently, the agent also performs the message exchanges with the original asymmetrical client, uploading data to the asymmetrical client, but not requesting pieces of the content back from (i.e. over the reverse link) the asymmetrical client.

The net result is that other swarm members do not experience low bandwidth transfers throttled by the reverse link bandwidth of the asymmetrical client, and, more importantly, demands for the limited reverse link bandwidth of all the asymmetrical clients is minimized. The former affords a better quality of experience for other swarm peers, and the latter affords a better quality of experience for the asymmetrical client and the operator serving the asymmetrical client.

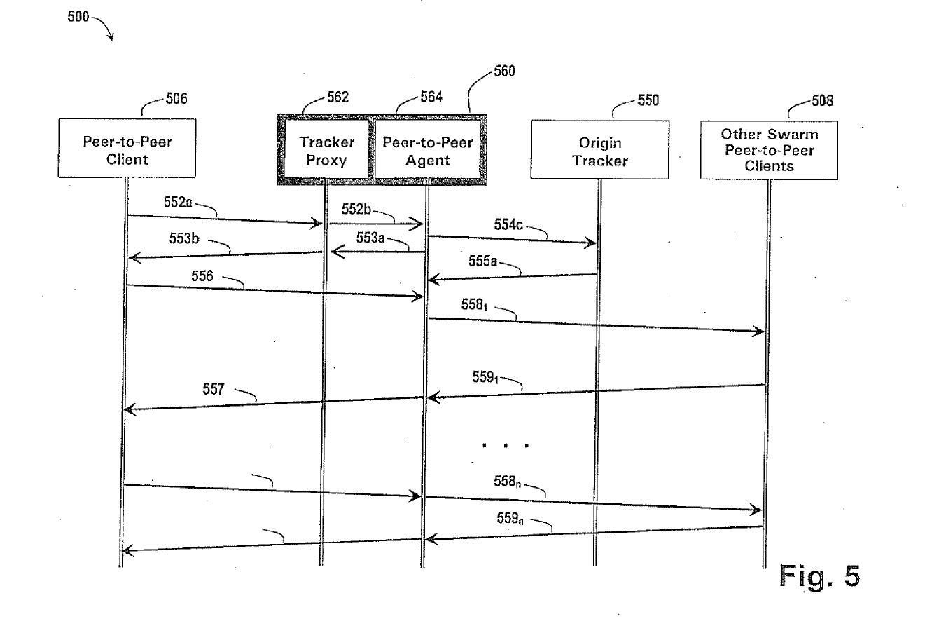

Referring to FIG. 5, there may be seen a message flow diagram 500 representative of a client joining a P2P overlay network 404 of FIG. 4. Represented in the message flow diagram are Peer-to-Peer Client 506, Origin Tracker 550, and other swarm peer-to-peer clients 508. In addition, there may be seen Peer-to-Peer Accelerator Proxy 560 having Tracker Proxy 562 and Peer-to-Peer Agent 564. In joining the swarm, client 506 sends bootstrap message 552a which is intercepted by Tracker Proxy 562 or alternatively, directed to Tracker Proxy 562. Tracker Proxy 562 instantiates Peer-to-Peer Agent 564 with the appropriate message transfer information 552b, and Agent

564 forwards a modified bootstrap request 552c to origin tracker 550. Origin tracker 550 responds with a peer list message 554a listing peers which may be accessed for the content which client 506 is seeking. Agent 564 receives the message 554a, and registers the information via a message exchange 554b with Proxy 562. Proxy 562 then forwards a modified peer list via message exchange 554c to client 506.

At this point agent 564 connects to the provided peers and exchanges data with them using the peer-to-peer content exchange protocol (e.g., using the BitTorrent protocol) as if it were the originating client 506 as per message exchanges (558₁ and 559₁, . . . , 558ₙ and 559ₙ). Concurrently, agent 564 performs a series of message exchanges (556₁ and 557₁, . . . , 556ₘ and 557ₘ) with client 506 conveying the relevant pieces of desired content received from other swarm peers. During this operation agent 564 abstains from requesting content pieces from client 506, avoiding reverse link content piece transfer.

At the conclusion of the file sharing session i.e. when client 506 leaves the swarm, agent 560 may also leave the swami.

Accordingly, what has been presented is a method and system for minimization of reverse or uplink usage in asymmetrically connected clients in a peer-to-peer overlay network. This includes wireline networks with asymmetrical connections such as ADSL, or wireless networks having a reverse airlink with less bandwidth than the forward link.

The benefits of the described method and system include an improvement of download rates for other members of the swarm, with a concurrent improvement of Quality of Experience as these peers are not receiving data pinched by the bottlenecking reverse link. As well, operators will notice an improvement in contention for reverse link bandwidth on wireless links, and a reduction in contention for oversubscribed aggregation links in wireline networks. In addition, mobile wireless clients operating their data appliance on battery power will notice a reduction of battery drain due to the reduced uplink data volumes and shorter download times.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium or loaded into and/or executed by a machine, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

It will be further understood that various changes in the details, materials, and arrangements of the parts which have been described and illustrated in order to explain the nature of this invention may be made by those skilled in the art without departing from the scope of the invention as expressed in the following claims.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.” Numerous modifications, variations and adaptations may be made to the embodiment of the invention described above without departing from the scope of the invention, which is defined in the claims.

What is claimed is:

1. A system for reducing reverse link bandwidth consumption in peer-to-peer networks, said system comprising:
a data network;
a peer-to-peer network operating in conjunction with said data network;
a client having an asymmetrical connection to said data network; and
a peer-to-peer proxy server located in said data network; and wherein
said peer-to-peer proxy server has a dedicated function of interfacing between said client and said peer-to-peer network.

2. A system as claimed in claim 1, wherein said peer to peer proxy server comprises
a tracker proxy for receiving bootstrap messages from an asymmetrically connected client; and
a mechanism for instantiating a peer-to-peer agent to represent a given asymmetrically connected client to said peer-to-peer network.

3. A system as claimed in claim 1, wherein said asymmetrical connection comprises a wireline connection.

4. A system as claimed in claim 3, wherein said wireline connection comprises an ADSL connection.

5. A system as claimed in claim 1, wherein said asymmetrical connection comprises a wireless connection.

6. A system as claimed in claim 5, wherein said wireless connection comprises an LTE connection.

7. A system as claimed in claim 5, wherein said wireless connection comprises a WiMAX connection.

8. A system as claimed in claim 5, wherein said wireless connection comprises an UMTS connection.

9. A system as claimed in claim 5, wherein said wireless connection comprises a GSM connection.

10. A system as claimed in claim 1, wherein
said peer-to-peer network operates using a BitTorrent protocol; and
said agent interfaces to said peer-to-peer network emulating a client using BitTorrent protocol.

11. A method for reducing reverse link bandwidth consumption in a peer-to-peer network operating in conjunction with a data network having at least one asymmetrically connected client; said method comprising the steps of:
intercepting a bootstrap message from said asymmetrically connected client;
instantiating an agent to represent said client;
performing peer-to-peer message exchanges from said agent to other peers wherein said agent performs content transfers normally performed by said asymmetrically connected client;
performing peer-to-peer message exchanges from said agent to said client wherein said agent performs content transfers normally performed by other peers to said client; and
avoiding requesting file content transfers from said client to said agent over said client's reverse link.

12. A method as claimed in claim 11, wherein said asymmetrically connected client is connected by a wireline connection.

13. A method as claimed in claim 12, wherein said wireline connection is an ADSL connection.

14. A method as claimed in claim 11, wherein said asymmetrically connected client is connected by a wireless connection.

15. A method as claimed in claim 14, wherein said wireless connection comprises an LTE connection.

16. A method as claimed in claim 14, wherein said wireless connection comprises a WiMAX connection.

17. A method as claimed in claim 14, wherein said wireless connection comprises an UMTS connection.

18. A method as claimed in claim 14, wherein said wireless connection comprises a GSM connection.

19. A method as claimed in claim 11, wherein said peer-to-peer message exchanges follow a BitTorrent protocol.

20. An article of manufacture, comprising a machine-accessible medium having instructions encoded thereon for enabling a processor to perform the operations of
intercepting a bootstrap message from an asymmetrically connected client connected to a data network;
instantiating an agent to represent said client to a peer-to-peer network operating in conjunction with said data network;
performing peer-to-peer message exchanges from said agent to other peers wherein said agent performs content transfers normally performed by said asymmetrically connected client;
performing peer-to-peer message exchanges from said agent to said client wherein said agent performs content transfers normally performed by other peers to said client; and
avoiding requesting file content transfers from said client to said agent over said client's reverse link.
